(19) United States
(12) Patent Application Publication
(10) Pub. No.: US 2016/0342954 A1
(43) Pub. Date: Nov. 24, 2016

(54) MULTI-PERSON ONLINE CALENDAR SYSTEMS AND METHODS

(71) Applicant: KIDDOApp, Inc., Tenafly, NJ (US)

(72) Inventor: Tzvia Bader, Tenafly, NJ (US)

(73) Assignee: KIDDOApp, Inc., Tenafly, NJ (US)

(21) Appl. No.: 15/156,861

(22) Filed: May 17, 2016

Related U.S. Application Data
(60) Provisional application No. 62/165,374, filed on May 22, 2015.

(51) Int. Cl. G06Q 10/10

(52) U.S. Cl. CPC G06Q 10/1095

(57) ABSTRACT

A method for managing a schedule of events for a family in an online calendar accessible by users over a communication network. The method includes: (a) assigning each user a role as parent user, child user, or other user; (b) generating a calendar grid for displaying events scheduled for the users at specified times, wherein each row or column of the calendar grid indicates the scheduled events at the specified times for a user; (c) entering new events in the calendar grid based on inputs received from client devices; (d) for at least some of said events for a child user, assigning a parent user or other user to be a person-in-charge to assume responsibility for the child user at the event; and (e) transmitting data to the client devices for displaying the calendar grid to the users.

### CROSS REFERENCE TO RELATED APPLICATION

This application claims priority from U.S. Provisional Patent Application No. 62/165,374 filed on May 22, 2015 entitled MULTI-PERSON ONLINE CALENDAR SYSTEMS AND METHODS, which is hereby incorporated by reference.

### BACKGROUND

The present application generally relates to methods and systems for managing schedules of multiple-connected people using a multi-person online calendar accessible by users on user computer devices.

### BRIEF SUMMARY OF THE DISCLOSURE

In accordance with one or more embodiments, a computer-implemented method is disclosed for managing a schedule of events for a family in an online calendar accessible by users over a communication network. The method includes the steps performed by a computer server system of: (a) assigning each user a role as parent user, child user, or other user based on inputs received from client devices operated by one or more users over the communication network; (b) generating a calendar grid for displaying events scheduled for the users at specified times, wherein each row or column of the calendar grid indicates the scheduled events at the specified times for a given user; (c) entering new events in the calendar grid based on inputs received from client devices operated by one or more users over the communication network; (d) for at least some of said events entered in the calendar grid for a child user, assigning a parent user or other user to be a person-in-charge to assume responsibility for the child user at the event; and (e) transmitting data to the client devices operated by the users over the communication network for displaying the calendar grid to the users.

### BRIEF DESCRIPTION OF THE DRAWINGS

FIG. 1 is a simplified diagram illustrating an exemplary multi-person online calendar system in accordance with one or more embodiments.

FIG. 2 is a simplified block diagram illustrating select components of a representative user computer device used for accessing the multi-person online calendar system in accordance with one or more embodiments.

FIGS. 3-20, 21A, 21B, and 21C illustrate various exemplary screens displayed on user devices in accordance with one or more embodiments.

### DETAILED DESCRIPTION

Various embodiments disclosed herein relate to computer-implemented methods and systems for organizing, managing, displaying, and coordinating everyday schedules of multiple connected individuals, where there is an underlying hierarchy of dependency among the individuals particularly, e.g., within a family. The scheduling system maintains an online multi-person calendar, which is accessible by families and other groups of users using smartphones and other computer devices. Families can use the online calendar to manage and coordinate schedules for family members. In one or more embodiments, the online multi-person calendar can be accessed through an app downloaded on each user's smartphone or other device.

The multi-person calendar allows family members to quickly and easily view and directly manage each other's daily schedules. The system allows users to conveniently add events to the calendar for themselves and other family members. In addition, the online calendar can be easily shared between parents and with people outside the family involved in scheduled events such as babysitters, tutors, and helpers. In addition, the calendar system allows users to invite friends to events and activities, and to RSVP to invitations for events and activities received from users in other families. The system also allows users to assign particular users who are responsible (i.e., “in-charge”) for scheduled activities or tasks such as pickups or drop-offs. In addition, the system can display a map on user devices, allowing users to see locations of all of the scheduled events for the day as pin-points on the map and to get directions to the locations, if needed.

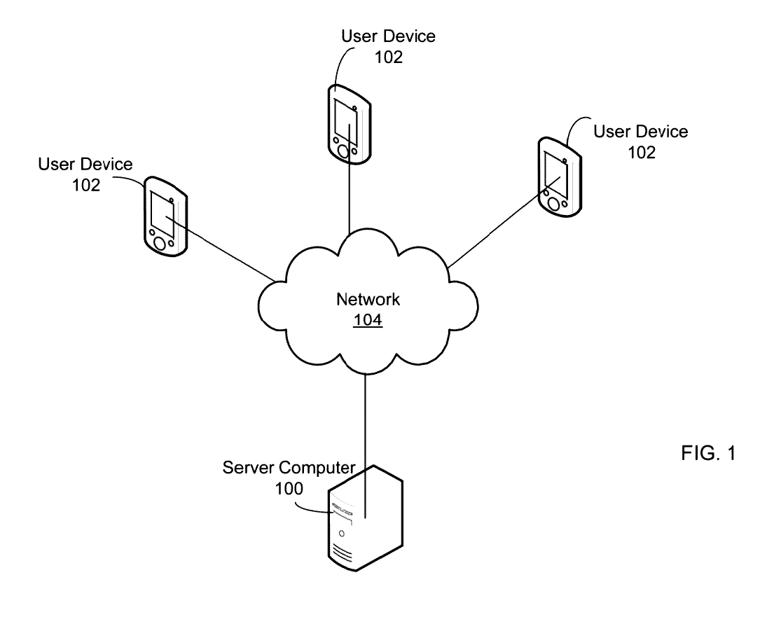

FIG. 1 illustrates an exemplary network, in which an online multi-person calendar system 100 in accordance with one or more embodiments may be implemented. The calendar system 100 is preferably implemented in a computer server system, which communicates with a plurality of client devices 102 operated by the users of the system 100. The client devices 102 communicate with the system 100 over a communications network 104. The communications network 104 may comprise any network or combination of networks including, without limitation, the Internet, a local area network, a wide area network, a wireless network, and a cellular network.

The client devices 102 operated by users to access the calendar system 100 can comprise any generally computing device that can communicate with the computer server system 100 including, without limitation, personal computers (including desktop, notebook, and tablet computers), smart TVs, smartphones (e.g., the Apple iPhone and Android-based smart phones), wearable computer devices (e.g., smart watches and smart glasses), cell phones, personal digital assistants, and other mobile devices. The client devices 102 include operating systems (e.g., Android, Apple iOS, and Windows Phone OS, among others) on which applications run. The operating systems allow programmers to create applications (often called “apps”) to provide particular functionality to the devices. Users can download a multi-person calendar app (sometimes referred to herein as the KIDDOapp) on their smartphones or other devices to access the calendar system. Alternatively or in addition, the calendar system can be accessed by users through a web-based interface on the user device.

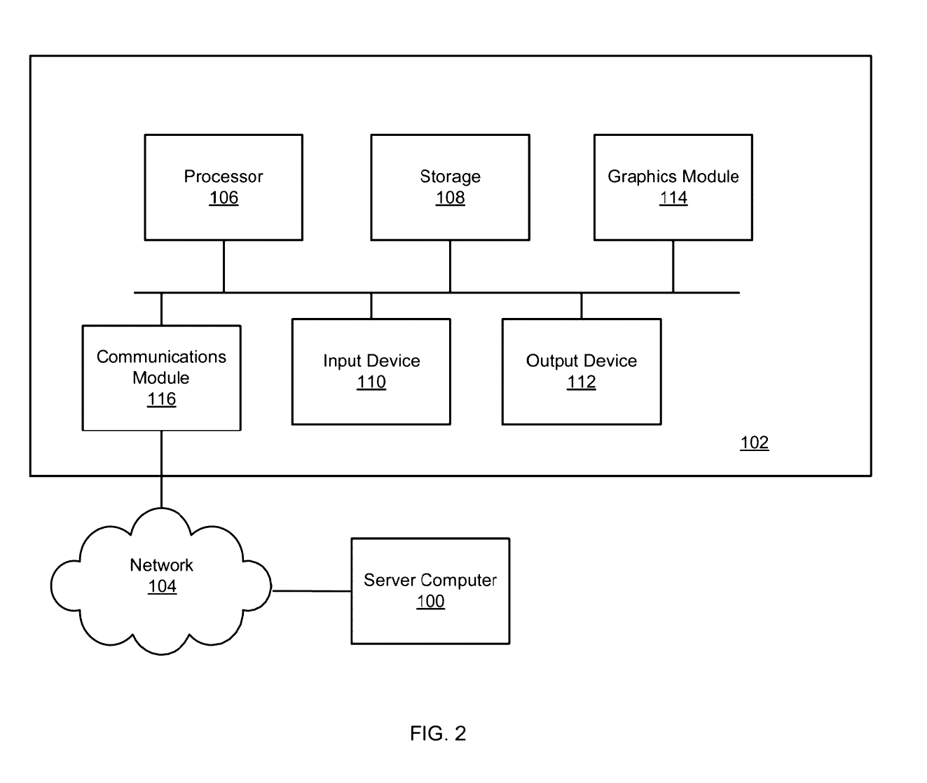

FIG. 2 is a functional block diagram illustrating select components of a representative user computer device 102 in accordance with one or more embodiments. The device 102 includes at least one computer processor 106 and a storage medium 108 readable by the processor 106 for storing the operating system, applications, and data. The device 102 also includes input/output devices 110, 112 such as, e.g., a camera, one or more speakers for acoustic output, a microphone for acoustic input, and a display for visual output, e.g., an LCD or LED display, which may have touch screen input capabilities. The device also includes a graphics module 114 for generating graphical objects. The device also includes a communication module or network interface 116 to communicate with a computer server 100 or other devices via telecommunications and other networks 104.

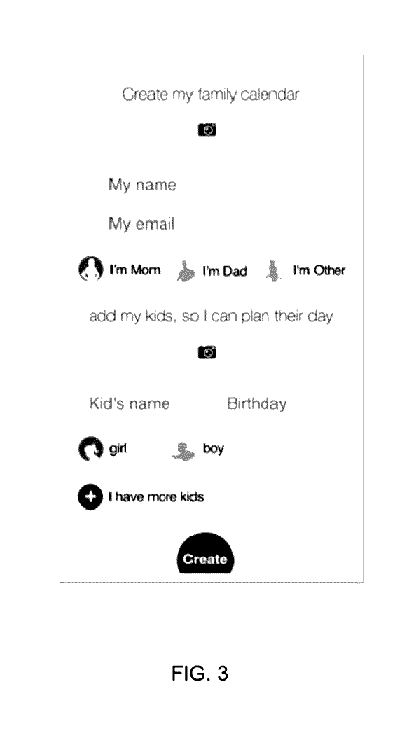

Users of the system have particular role definitions in accordance with one or more embodiments. For a multi-person family calendar, each user signs up as a parent (‘mother’ or ‘father’), child, or ‘Other’ (e.g., a grandparent or other relative, babysitter, or tutor) as shown in the exemplary sign-in screen of FIG. 3. This provides the basis for maintaining hierarchical data in the calendar and for maintaining the dependency relevant to event creation in the multi-person calendar, assigning a person-in-charge for an event, and other multi-person scheduling functionality.

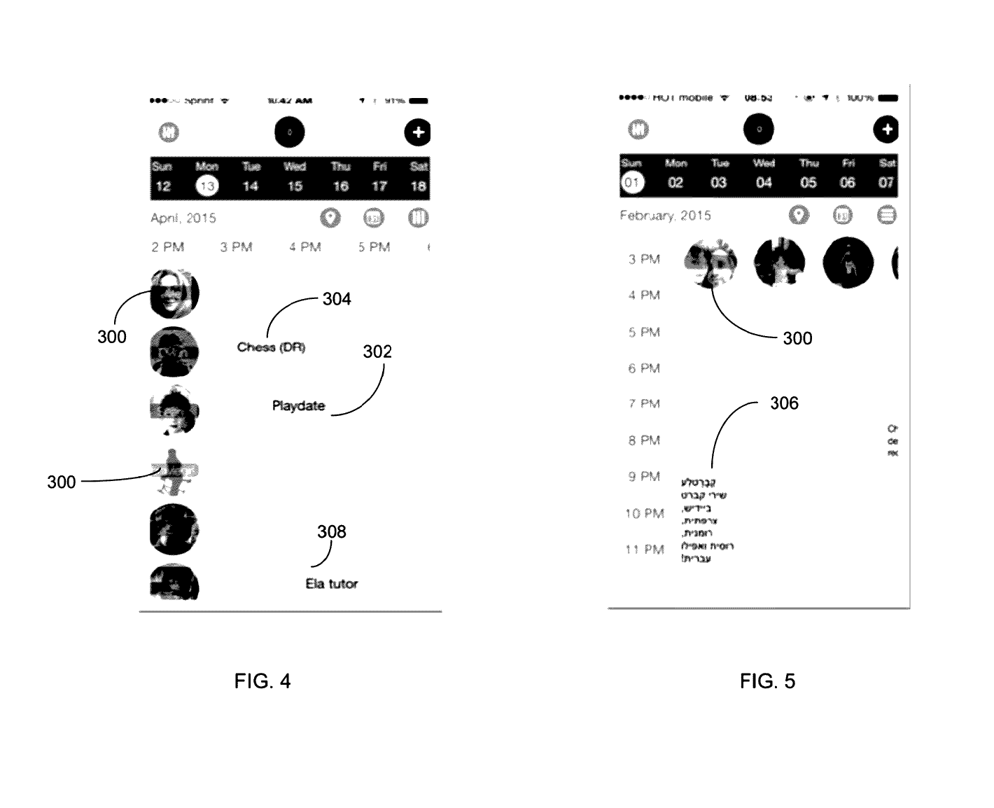

FIGS. 4 and 5 are screenshots of two exemplary views of a multi-person family calendar displayed on a user device in accordance with one or more embodiments. The calendar shows a schedule for multiple family members (represented by icons/photographs 300 for easy identification) for a given day. The calendar events 302, 304, 306 are organized and presented in a grid format. Users can switch between a horizontal view where each person's schedule is presented in a row as shown in FIG. 4, or a vertical view where each person's schedule is presented in a column as shown in FIG. 5.

In accordance with one or more embodiments, the scheduled events 302, 304, 306 are color-coded, i.e., each of the events is highlighted in a particular color in order to indicate which of the users is assigned as the person-in-charge for the event.

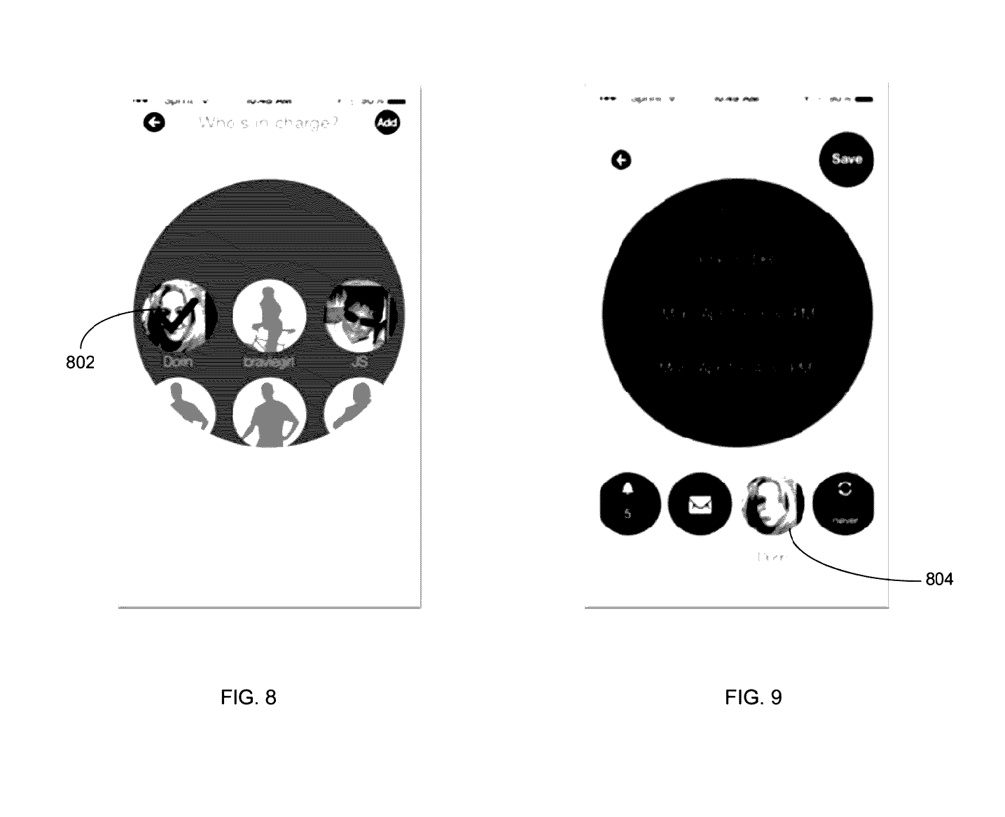

The calendar system recognizes that there is a hierarchy among family members, where some individuals—either young children or older individuals—may be dependent on other members of the family or outside caregivers for their day-to-day care. As discussed below, in connection with FIGS. 8 and 9, the calendar system includes an “In-Charge” feature that enables a responsible adult to be assigned to be the “person-in-charge” of an event. This usually means that the designated adult assumes the responsibility for taking a dependent family member to and from an event.

In the calendar shown in FIGS. 4 and 5, events 302 and 304 for children in the family are highlighted in blue to indicate that there is a person in-charge assigned. A small checkmark icon 308 can indicate that the “in charge” assigned person has accepted the event and acknowledged his/her responsibility. This event is shown on the schedule of the dependent child and the particular adult in-charge. In this example, it is the father in the family who is the person-in-charge and responsible for taking the children to those events.

The color coding of events lets users of the system distinguish between the types of events on their calendar. For example, it shows the user if events were imported from their personal calendar (color pink), if they are in charge of an event (color blue), if the events were created using the KIDDOapp interface (color grey-blue), or if a friend is placed in-charge (color purple). This color coding allows users to very quickly and easily distinguish between their work/personal schedule and family schedule including who is responsible for which scheduled event and to ensure that events for children have an assigned person-in-charge.

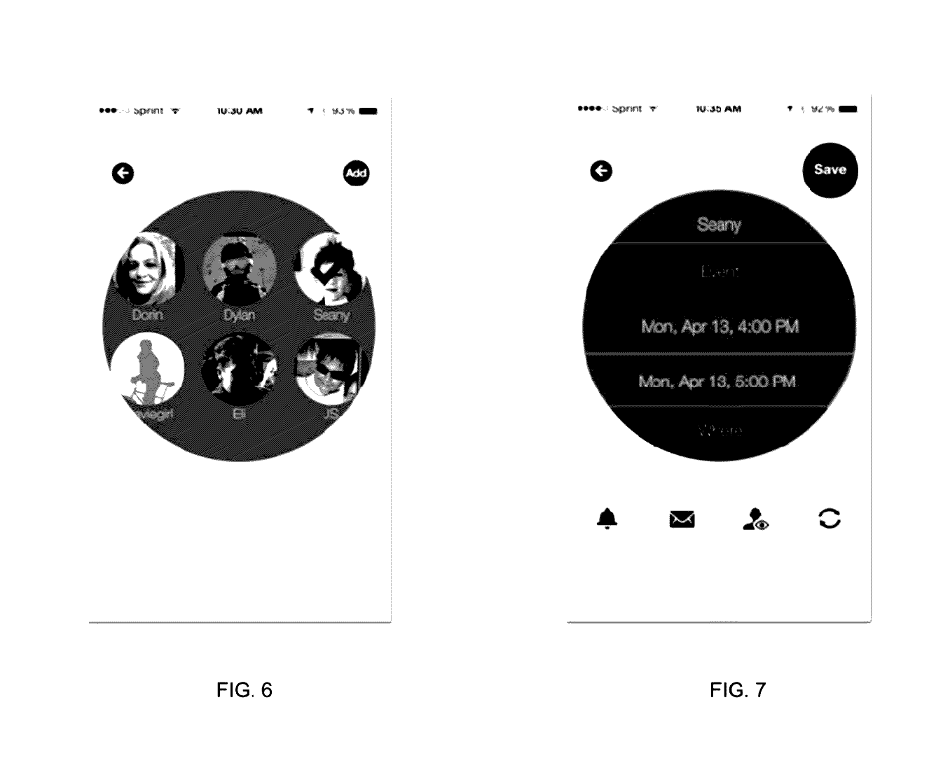

The multi-person calendar distinguishes between the events/appointments created for each individual in the family visually by presenting them in a different rows or columns on the calendar next to the individual's icon/picture as shown, e.g., in FIGS. 4 and 5. The calendar also enables users to send invitations to events relating to a particular individual as illustrated in the exemplary screenshots of FIGS. 6 and 7. To add an event to the multi-person calendar, a user first identifies the individual participating in the event. This can be done in the exemplary screen shown in FIG. 6. Here, the individual to which the event applies (‘Seany’ in this example) is selected as indicated by the checkmark on his photograph/icon. The user is then taken to the screen of FIG. 7, where the event can be added by inputting details of the event, including an identification of the event, the time of the event, and the place of the event. As family events may involve more than one individual, several individuals can be selected at this step and in that case the event will show on each individual's row/column.

FIGS. 8 and 9 are exemplary screens showing assignment of a person-in-charge for an event. As part of the event creation process discussed above in connection with FIGS. 6 and 7, the user creating an event is asked to select the person-in-charge of the event as shown in the exemplary screen of FIG. 8. In this example, user “Dorin” 802 is the selected person-in-charge, and her photograph 804 is shown in the FIG. 9 exemplary event details screen in place of the in-charge icon. The system then creates an invitation for Dorin to respond by accepting or declining being placed “in charge” of an event. If Dorin accepts, the event is then added to her own schedule in blue and a small “yes” checkmark is added to the meeting so that the organizer knows that the in-charge invitation was accepted (e.g., checkmark 308 in FIG. 4).

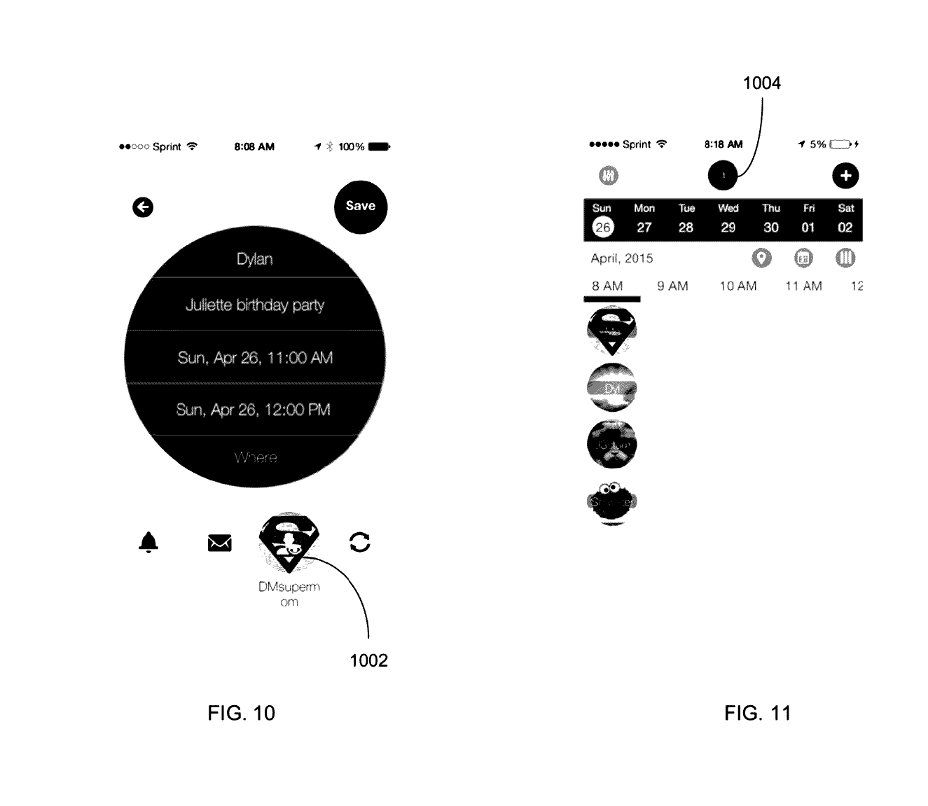

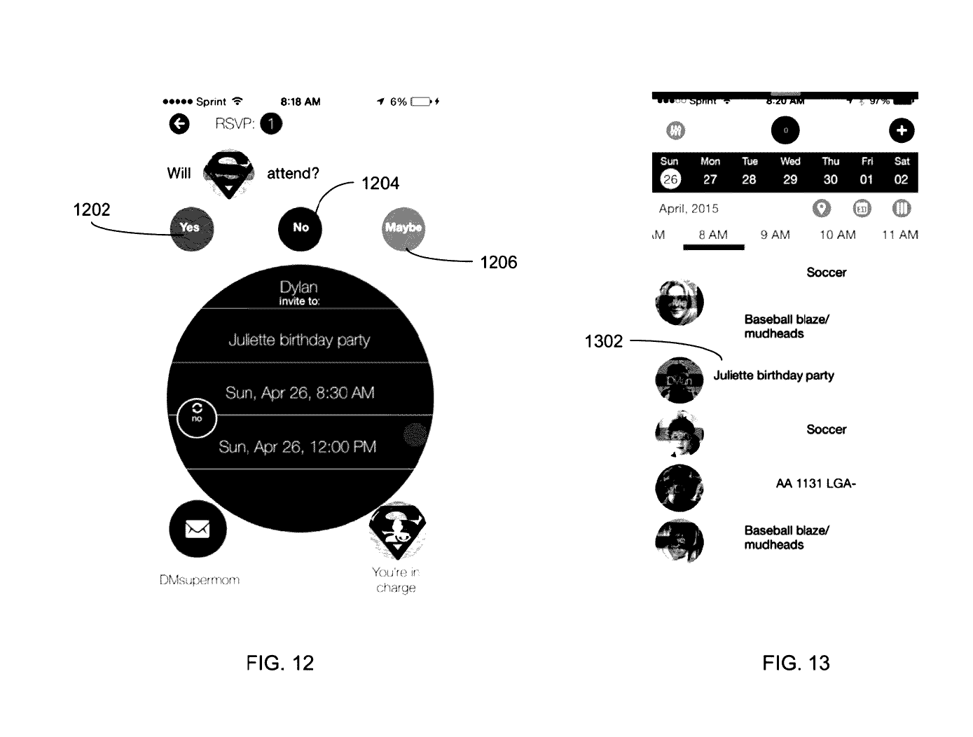

FIGS. 10-13 are screenshots illustrating the process of inviting someone to be a person-in-charge for an event. As shown in FIG. 10, a user creates an event inviting user named “DMSuperMom” to be the person-in-charge for an event as indicated by icon 1002. As shown in FIG. 11, which shows the calendar of DMSuperMom, a purple circle 1004 containing the number “1” indicates one invitation arrived for DMSuperMom. The invitation indicates that DMSuperMom was placed in-charge of an event. As shown in FIG. 12, in response to the invitation, DMSuperMom can accept, decline, or indicate maybe using the action buttons 1202, 1204, 1206, respectively. If DMSuperMom accepts, the acceptance is indicated on the calendar of the creator of the event. As shown in FIG. 13, the color of the event and the small checkmark icon 1302 (top left corner of event “Juliette's Birthday Party”) indicates that there is a person in charge of the event.

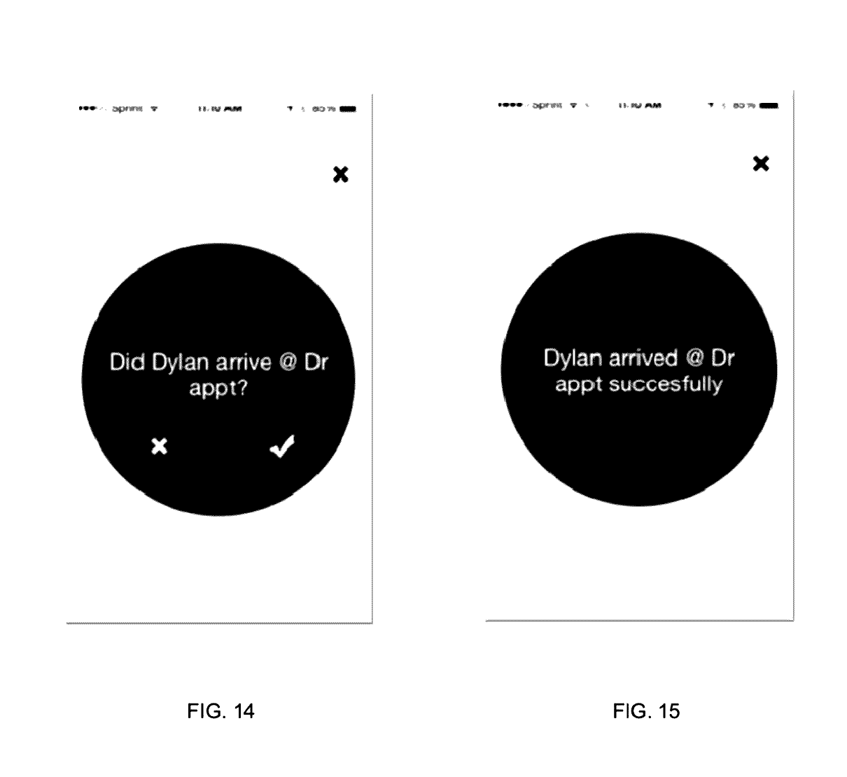

In accordance with one or more embodiments, the calendar system provides contextual messages to remind to the person-in-charge of an event and prompts them to acknowledge arrival or departure from the scheduled event location as shown in the exemplary pop-up shown in FIG. 14. The event creator—within a family context this is typically a parent—gets a pop-up notification on his or her user device to inform them that their child has successfully arrived (or not) at the scheduled event, as shown in the exemplary screen of FIG. 15. This is also shown via the notification center of the mobile device.

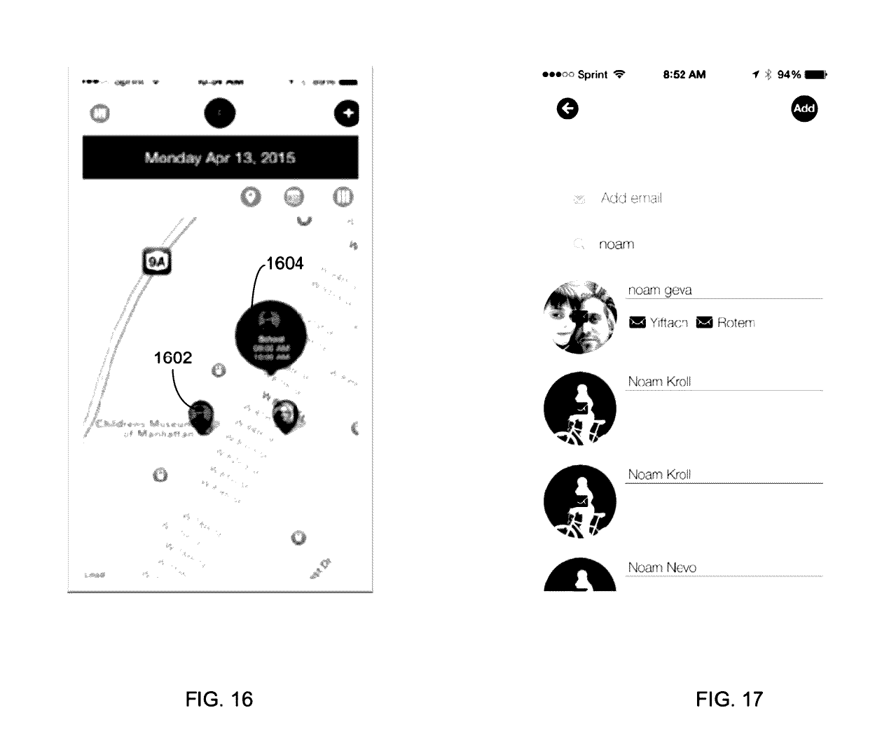

In accordance with one or more embodiments, the calendar system can display scheduled calendar events of each day on a map, with pin-points 1602 indicating the locations of the different events of the day, as shown in the exemplary screen of FIG. 16. The pin-points each contain an icon/photograph for the person whose event it is. This presentation allows the user to get an overall sense of the path that their day will take across a certain geography, allowing them to plan their day and make travel plans accordingly. The next event scheduled is shown in a larger pin point 1604, allowing the user to get a context of timing and what is next on their agenda.

A single tap on a pin-point opens up the event details screen for more detailed information on the event. A single tap on the event location switches the user to their mobile device's GPS navigation app such as, e.g., the Google Maps app, to obtain directions to the event.

In accordance with one or more embodiments, when saving information about each user in a multi-person family, the calendar system organizes and manages the hierarchy and relationships within a family as a Proxy Graph. The system can thereby distinguish between parents, young/dependent children, semi-independent teen agers, and other relevant individuals who are involved in the family's child care including, e.g., grandparents and other adult relatives and various caregivers (babysitters, nannies, drivers, etc.). FIG. 17 shows how the calendar system, based on the information users enter at sign-up, shows the multi-person hierarchy (in this case a father and his two children). This allows users to select which children they want to invite to an activity together, simplifying the invitation and RSVP process for the parents of multiple children.

The Proxy Graph enables individual-invitations and RSVPs. When inviting a person to be involved in any given event, the invitation can specify the person within the multi-person family it is for, e.g., Jesse M. is invited to Dylan S.'s playdate. This provides a more efficient way of managing a family schedule for parents. The system simplifies the process of inviting, accepting invitations and scheduling activities together for families with multiple children. Each invitation specifies which child is invited to which friend's event, as all the information needed to invite and accept an invitation is provided in the event context.

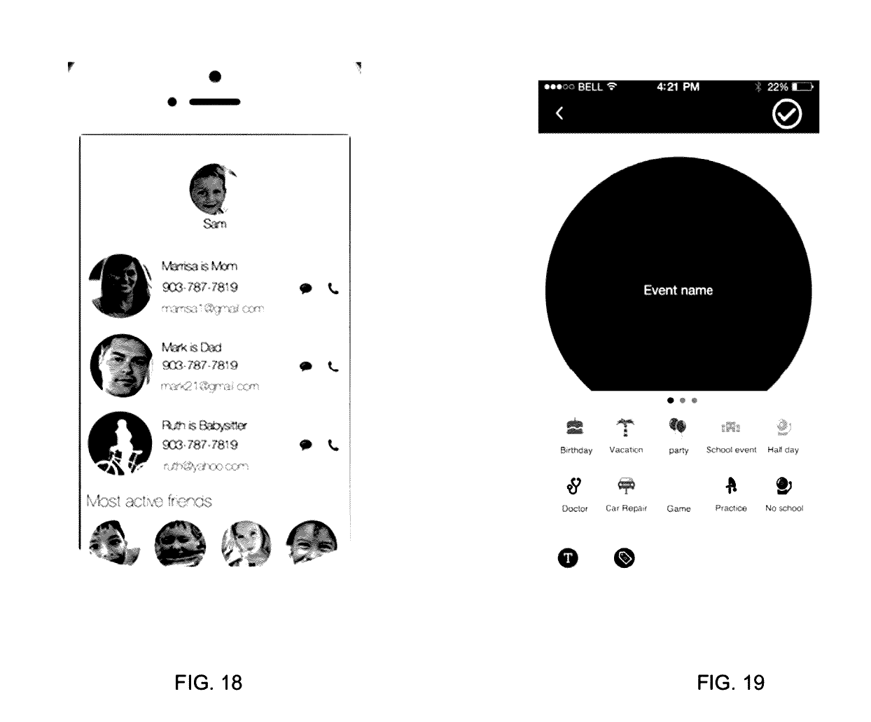

In accordance with one or more embodiments, the calendar system facilitates communication between different families who may share a scheduled event. For example, when pooling together resources (e.g., carpooling to baseball game with friends), a parent from one family can be informed by the system that it is it is the uncle of a child in the other family who is driving them and provide the uncle's phone number allowing him to be reached easily. This facilitate quick communication and lowers the need in having multiple communications in order to reach the person in charge. As another example, a father asked to pick up the children from a playdate at a friend's grandmother's house. As shown in FIG. 18, for a child named Sam, the system identifies his Mom, Dad and Babysitter, allowing a clear and easy path to reach any one of them.

In accordance with one or more further embodiments, the calendar system includes a pop-up rapid event creation keyboard as shown, e.g., in FIG. 19. This feature allows for even faster and more efficient addition of new calendar events. Furthermore, the system can include a pop-up calendar that will auto-fill more information and save additional steps for the user.

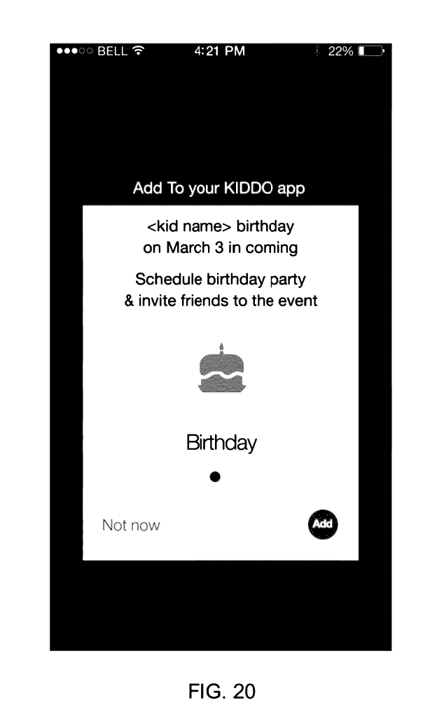

In accordance with one or more further embodiments, the system provides a dedicated customized keyboard that enables an even faster multi-person event creation as shown, e.g., in FIG. 20. The keyboard is accessible from anywhere within the mobile device (any phone, iPad screen) and when the user taps the keyboard they can create a multi-person event in the calendar system or in the default native calendar from anywhere in the phone without the need to open the calendar app and without having to toggle between applications. For example, a user looking at an email invitation from a non-app user can use this dedicated keyboard to create their KIDDOapp entry with the invitation email remaining visible to them.

In accordance with one or more further embodiments, the calendar system includes a calendar exchange feature. The system enables users to subscribe to calendar schedules posted by companies and entities such as, e.g., schools, sports leagues, and community centers. This feature allows users to efficiently add entire seasonal schedules of activities to their family calendars without having to do the data entry themselves, while additionally ensuring that the users get any schedule changes updated in real-time. For example, a snow day school closure or game cancellation will be instantly reflected on the user's calendar and prompted with an alert.

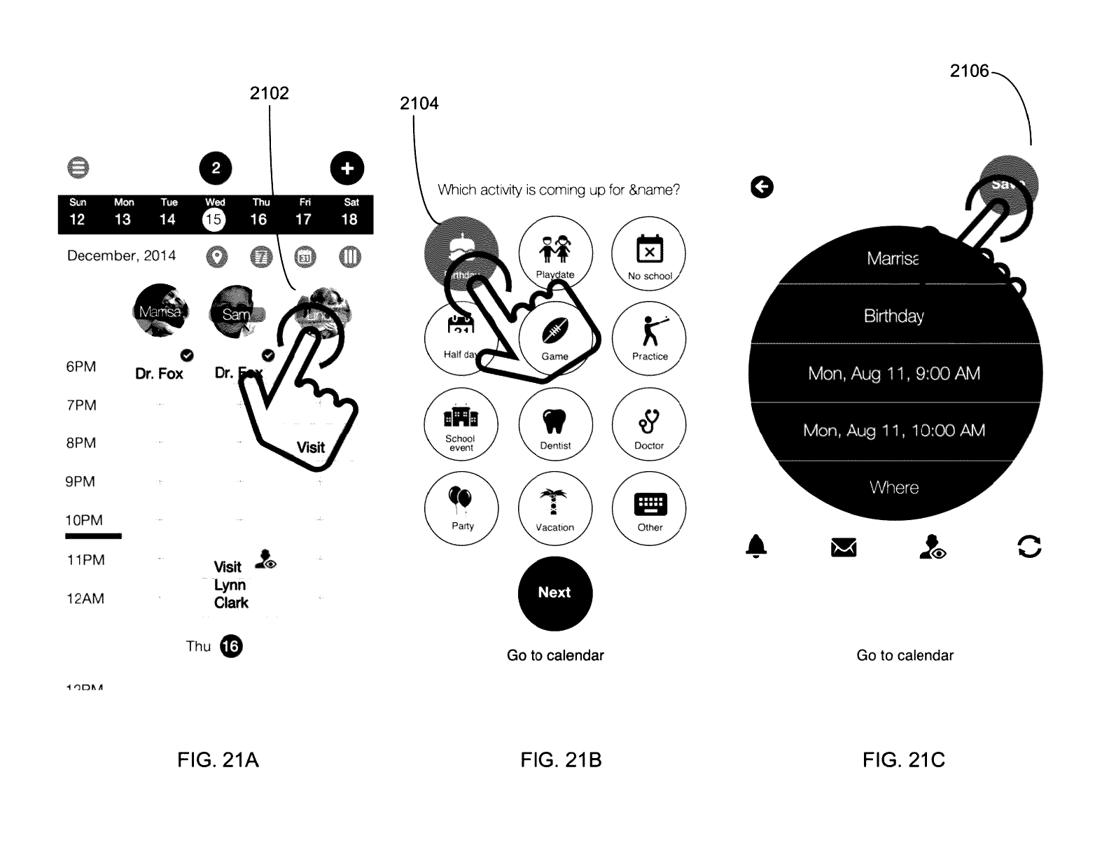

FIG. 21A, 21B, and 21C (collectively FIG. 21) illustrate a simplified new event scheduling process in accordance with one or more embodiments. In the illustrated example, new events can be created in the calendar with few clicks. First, as shown in FIG. 21A, a user clicks on the relevant child icon/picture at 2102 and time period on the calendar grid. In response, the app opens pre-existing templates identifying typical kids' activities as shown in FIG. 21B. In this example, the user selects a birthday icon 2104. These selections cause the app to open and pre-fill an event details screen as shown in FIG. 21C. The user the simply clicks the save button 2106 to complete the new event scheduling process.

The processes of the online calendar system 100 described above may be implemented in software, hardware, firmware, or any combination thereof. The processes are preferably implemented in one or more computer programs executing on a programmable computer (which can be part of the server computer system) including a processor, a storage medium readable by the processor (including, e.g., volatile and non-volatile memory and/or storage elements), and input and output devices. Each computer program can be a set of instructions (program code) in a code module resident in the random access memory of the computer. Until required by the computer, the set of instructions may be stored in another computer memory (e.g., in a hard disk drive, or in a removable memory such as an optical disk, external hard drive, memory card, or flash drive) or stored on another computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions. For example, the computer server system may comprise one or more physical machines, or virtual machines running on one or more physical machines. In addition, the computer server system may comprise a cluster of computers or numerous distributed computers that are connected by the Internet or another network.

Accordingly, the foregoing description and attached drawings are by way of example only, and are not intended to be limiting.

1. A computer-implemented method of managing a schedule of events for a family in an online calendar accessible by users over a communication network, said method comprising the steps performed by a computer server system of:
(a) assigning each user a role as parent user, child user, or other user based on inputs received from client devices operated by one or more users over the communication network;
(b) generating a calendar grid for displaying events scheduled for the users at specified times, wherein each row or column of the calendar grid indicates the scheduled events at the specified times for a given user;
(c) entering new events in the calendar grid based on inputs received from client devices operated by one or more users over the communication network;
(d) for at least some of said events entered in the calendar grid for a child user, assigning a parent user or other user to be a person-in-charge to assume responsibility for the child user at the event; and
(e) transmitting data to the client devices operated by the users over the communication network for displaying the calendar grid to the users.

2. The method of claim 1, further comprising displaying a map to users showing locations of scheduled events for a given day as pinpoints on the map.

3. The method of claim 2, wherein the pinpoint of the next scheduled event is differentiated on the map from other pinpoints.

4. The method of claim 1, wherein step (d) comprises receiving from a first user a request to create an event with an invitation for a second user to be the person-in-charge for the event, forwarding the invitation to the second user, receiving an acceptance of the invitation by the second user; and indicating the acceptance on the calendar grid.

5. The method of claim 1, further comprising color-coding a scheduled event in the calendar grid to indicate which of said users is assigned as the person-in-charge for the event.

6. The method of claim 1, wherein the other user comprises a caregiver, a babysitter, a driver, a tutor, a relative, a helper, or a nanny.

7. The method of claim 1, wherein the client devices comprise laptop computers, desktop computers, tablet computers, smartphones, or wearable computer devices operated by the users.

8. The method of claim 1, wherein the users access the online calendar through an app or a web browser on their respective client devices.

9. The method of claim 1, further comprising color coding events on the calendar grid to indicate whether they were imported from a personal calendar of a user or created using a client device app interface.

10. The method of claim 1, wherein each user is indicated in the calendar grid by an icon or a picture of the user.

11. The method of claim 1, further comprising prompting the person-in-charge assigned to a scheduled event to acknowledge arrival or departure from a location of the event, and further comprising transmitting said acknowledgment to a parent user.

12. The method of claim 1, further comprising facilitating communication between different families sharing a common scheduled event.

13. The method of claim 1, wherein a user can create a new event for the calendar grid by clicking on a picture or icon representing a child user on the calendar grid, clicking on a time period for the event, and selecting an icon representing the event, and wherein a pop-up event generator on the user device is automatically populated based on items clicked by the user.

14. The method of claim 1, further comprising subscribing to one or more calendar schedules from one or more entities and automatically populating the calendar grid with events from the one or more calendar schedules.

15. A computer system, comprising:
at least one processor;
memory associated with the at least one processor; and
a program supported in the memory for managing a schedule of events for a family in an online calendar accessible by users over a communication network, the program containing a plurality of instructions which, when executed by the at least one processor, cause the at least one processor to:
(a) assign each user a role as parent user, child user, or other user based on inputs received from client devices operated by one or more users over the communication network;
(b) generate a calendar grid for displaying events scheduled for the users at specified times, wherein each row or column of the calendar grid indicates the scheduled events at the specified times for a given user;
(c) enter new events in the calendar grid based on inputs received from client devices operated by one or more users over the communication network;
(d) for at least some of said events entered in the calendar grid for a child user, assign a parent user or other user to be a person-in-charge to assume responsibility for the child user at the event; and
(e) transmit data to the client devices operated by the users over the communication network for displaying the calendar grid to the users.

16. The system of claim 15, wherein the program further comprises instructions for displaying a map to users showing locations of scheduled events for a given day as pinpoints on the map.

17. The system of claim 16, wherein the pinpoint of the next scheduled event is differentiated on the map from other pinpoints.

18. The system of claim 15, wherein the program further comprises instructions for color-coding a scheduled event in the calendar grid to indicate which of said users is assigned as the person-in-charge for the event.

19. The system of claim 15, wherein the program further comprises instructions for prompting the person-in-charge assigned to a scheduled event to acknowledge arrival or departure from a location of the event, and further comprising transmitting said acknowledgment to a parent user.
